(19) United States
(12) Patent Application Publication
(10) Pub. No.: US 2013/0253095 A1
(43) Pub. Date: Sep. 26, 2013

(54) Plasticizers for Resin Compositions and Resin Compositions Including the Same

(71) Applicants: Seung Gweon Hong, Daejeon (KR); Jin Su Ham, Daejeon (KR); Tae Wook Kwon, Daejeon (KR); Ki Nam Chung, Daejeon (KR)

(72) Inventors: Seung Gweon Hong, Daejeon (KR); Jin Su Ham, Daejeon (KR); Tae Wook Kwon, Daejeon (KR); Ki Nam Chung, Daejeon (KR)

(73) Assignee: SK Innovation Co., Ltd., Seoul (KR)

(21) Appl. No.: 13/989,867

(22) PCT Filed: Nov. 28, 2011
(86) PCT No.: PCT/KR2011/009113

§ 371 Date: May 28, 2013

(30) Foreign Application Priority Data
Nov. 29, 2010 (KR) 10-2010-0119661
Nov. 24, 2011 (KR) 10-2011-0123638

(51) Int. Cl. C08K 5/11

(52) U.S. Cl. CPC C08K 5/11
USPC 523/456; 524/308; 560/198

(57) ABSTRACT

This invention relates to a resin composition using a dicarboxylic acid diester derivative as a plasticizer, and particularly to a resin composition, which is obtained by adding the plasticizer to one or more resins selected from among aliphatic or aromatic polycarbonate resins, polyurethane resins, polyvinyl chloride resins and epoxy resins, and which has a low glass transition temperature (Tg) and can be easily processed and can impart flexibility to products. This plasticizer exhibits high plasticization efficiency, and a resin composition including the plasticizer can manifest a low glass transition temperature and good flexibility at low temperature, thus improving physical properties such as tensile strength, even when only a small amount of the plasticizer is added.

### TECHNICAL FIELD

The present invention relates to a plasticizer for a resin composition, comprising a dicarboxylic acid diester derivative obtained by condensing a dicarboxylic acid and an alcohol including ether, and to a plastic including the plasticizer, in particular, a resin composition including the plasticizer and one or more resins selected from among polyvinyl chloride (PVC) resins, epoxy resins, polyurethane resins and aliphatic or aromatic polycarbonate resins. Plastics produced from the resin composition including the plasticizer according to the present invention are advantageous because they may exhibit superior tensile strength and low glass transition temperature and thus may be efficiently formed into films, and also because they may maintain flexibility even at low temperature, making it possible to process them into flexible products such as films or artificial leather sheets, and also because they are very compatible with the above resins and thus bleeding does not occur, and also because they dissolve to a smaller extent in organic solvents or water, thus lengthening the lifetime of products such as films, sheets and so on manufactured from the above resin composition.

### BACKGROUND ART

Polyvinyl chloride resins, which are vinyl chloride homopolymers or copolymers containing 50% or more of vinyl chloride, are general-purpose resins that may be applied using a process such as extrusion molding, injection molding, calendaring, sol casting, etc., and are thus widely utilized as a material to make a variety of products including pipes, electric wires, electrical and mechanical products, toys, films, sheets, artificial leather, tarpaulin, tape, food packing materials, medical products and so on.

Examples of polyurethanes include thermoplastic polyurethanes which may be subjected to injection molding or extrusion molding, polyurethane sols useful for artificial leather, coatings, covers and fillers for electric and electronic devices, and polyurethanes resulting from post curing of a polyalcoholic oligomer and isocyanate. These polyurethanes may be processed not only into a variety of films, gloves, and artificial leather products, but also into electric and electronic protective films, coatings, interior construction materials, etc., and are thus widely utilized.

Epoxy resins are variously employed in interior construction materials and as fillers for electric and electronic devices, and one-solution or two-solution post-curing products are typical. In particular, these resins may impart plasticity when used as interior construction materials.

A typical example of polycarbonate is an aromatic polycarbonate using bisphenol A, but the use of aliphatic polycarbonate is increasing to improve properties of aromatics. In particular, aliphatic polycarbonate which is receiving attention as an environmentally friendly polycarbonate may include polypropylene carbonate resulting from copolymerizing propylene oxide (PO) and carbon dioxide, and polyethylene carbonate obtained by copolymerizing ethylene oxide (EO) and carbon dioxide via a similar reaction route. Also, in order to improve the mechanical properties thereof, terpolymers comprising cyclohexene oxide, glycidyl ethers, glycidyl esters in addition to PO and EO have been developed and applied.

The polyvinyl chloride resins, the polyurethane resins, the epoxy resins or the polycarbonate resins may impart a variety of processing properties by appropriately adding additives such as plasticizers, stabilizers, viscosity adjusting agents, internal release agents, pigments, etc. Among the additives, the plasticizer is essential because it may impart various properties and functions such as processability, flexibility, adhesion and so on by being added to the above resins. The plasticizer should have very low volatility, and its performance should continue to retain the properties not only during the molding of the plastic composition using the above resins but also during the actual use of the molded products. Also, the plasticizer, which is applied to the fields of food, drinks, and medicines and to end uses that put it in a position of being able to be put into contact with the human body, should be harmless to the human body. In the case of interior construction materials, the discharge of volatile organic compounds should be retarded. The plasticizer used therefor to date may include dialkyl phthalate. Particularly useful as polycarbonate is an ester compound of citric acid or a dibasic ester such as dioctyl adipate. However, the use of dialkyl phthalate is considered to be remarkably reduced in the near future because of it being denounced for its toxicity when being reproduced under laws that regulate toxic materials in terms of stability to the human body. Moreover, in the case of polypropylene carbonate or polyethylene carbonate and copolymers thereof with glycidyl ether or glycidyl ester, a plasticizer such as dialkyl phthalate or dibasic ester has insufficient plasticity. When the amount of the plasticizer is low to the extent of 10% or less, it is difficult to sufficiently decrease the glass transition temperature. To ensure the desired flexibility, the use thereof should be increased. In this case, surface stickiness of the processed resin composition may undesirably increase.

### DISCLOSURE OF INVENTION

### Technical Problem

In order to solve the problems encountered in the related art, the present inventors conducted intensive and thorough research into the use of a dicarboxylic acid diester derivative obtained by condensation of dicarboxylic acid and alcohol including ether, as a plasticizer for a resin composition comprising one or more resins selected from among a polyvinyl chloride resin, a polyurethane resin, an epoxy resin and a polycarbonate resin. The research was conducted with the expectation of compatibility thereof with respective resins, and included research into the performance of test samples thereof as a plasticizer, resulted in the finding that the dicarboxylic acid diester derivative may be used as a plasticizer, and may be particularly useful as a plasticizer for polyvinyl chloride resins, which culminates in the present invention.

Therefore, an object of the present invention is to provide a plasticizer for a resin composition, which comprises a dicarboxylic acid diester derivative having superior properties able to replace conventional plasticizers comprising dialkyl phthalate or dibasic ester, and a resin composition comprising the plasticizer and one or more resins selected from among a polyvinyl chloride resin, an epoxy resin, a polyurethane resin and a polycarbonate resin.

### Solution to Problem

In one aspect, provided is a plasticizer for a resin composition, comprising a dicarboxylic acid diester derivative represented by Chemical Formula 1 below.

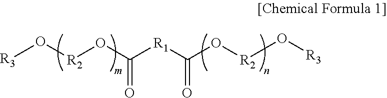

In Chemical Formula 1, R₁ and R₂ independently represent linear or branched (C1-C8)alkylene, alicyclic (C5-C10)alkylene or (C6-C12)arylene; R₃ represents linear or branched (C1-C18)alkyl, alicyclic (C5-C10)alkyl or (C6-C12)aryl; and m and n independently represent an integer of 0˜8, provided that the case where both m and n are 0 is excluded.

In another aspect, provided is a resin composition, comprising one or more resins selected from among a polyvinyl chloride resin, a polyurethane resin, an epoxy resin and a polycarbonate resin and the plasticizer represented by Chemical Formula 1.

Hereinafter, a detailed description will be given of the present invention.

The present invention provides, as a plasticizer for a resin composition, a dicarboxylic acid diester derivative represented by Chemical Formula 1 below.

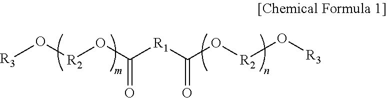

In Chemical Formula 1, R₁ and R₂ independently represent linear or branched (C1-C8)alkylene, alicyclic (C5-C10)alkylene or (C6-C12)arylene; R₃ represents linear or branched (C1-C18)alkyl, alicyclic (C5-C10)alkyl or (C6-C12)aryl; and m and n independently represent an integer of 0˜8, provided that the case where both m and n are 0 is excluded.

Particularly R₁ and R₂ independently represent methylene, ethylene, n-propylene, i-propylene, n-butylene, i-butylene, n-pentylene, i-pentylene, n-hexylene or i-hexylene, and may more particularly represent —CH₂—, —CH₂CH₂—, —CH₂CH₂CH₂—, —CH₂CH(CH₃)— or —CH(CH₃)CH₂—.

The dicarboxylic acid diester derivative of Chemical Formula 1 according to the present invention is obtained by condensation of dicarboxylic acid with alcohol including ether.

The plasticizer of Chemical Formula 1 according to the present invention is added to one or more resins selected from among a polyvinyl chloride resin, a polyurethane resin, an epoxy resin and a polycarbonate resin, thus preparing a resin composition. The amount of the plasticizer of Chemical Formula 1 which is added to the above resins is not limited, but may be set to 5˜150 parts by weight based on 100 parts by weight of one or more resins selected from among a polyvinyl chloride resin, a polyurethane resin, an epoxy resin and a polycarbonate resin. In the resin composition including the plasticizer, the amount of the plasticizer may be appropriately increased or decreased depending on the end use of the resin compositions. If the amount of the plasticizer is less than 5 parts by weight, flexibility or processability which may be exhibited by a plasticizer cannot be obtained. In contrast, if the amount of the plasticizer exceeds 150 parts by weight, it is difficult to ensure appropriate mechanical properties, and the viscosity may be excessively decreased.

The plasticizer according to the present invention may be mixed with one or more resins selected from among a polyvinyl chloride resin, a polyurethane resin, an epoxy resin and a polycarbonate resin, thus forming the resin composition. As such, the resins used are not limited thereto, and may include chlorine-containing resins such as chlorinated polyvinyl chloride, polyvinylidene chloride, chlorinated polyethylene, vinyl chloride-vinyl acetate copolymer, vinyl chloride-ethylene copolymer, vinyl chloride-propylene copolymer, vinyl chloride-styrene copolymer, vinyl chloride-isobutylene copolymer, vinyl chloride-vinylidene chloride copolymer, vinyl chloride- any vinyl ether copolymer, blends thereof, and blends, block copolymers or graft copolymers of chlorine-containing resins and synthetic resins having no chlorine, for example, acrylonitrile-styrene copolymer, acrylonitrile-styrene-butadiene terpolymer, ethylene-vinyl acetate copolymer or polyester.

The polyvinyl chloride resin composition including the plasticizer according to the present invention may be prepared using a method well known in the art. For example, this method may include adding the plasticizer to a resin having a molecular weight sufficiently increased by crosslinking or curing or to an oligomeric precursor and then performing curing.

The epoxy resin composition including the plasticizer according to the present invention may be prepared using a method well known in the art. For example, this method may include adding the plasticizer before curing is carried out using a curing agent.

The polycarbonate resin composition including the plasticizer according to the present invention may be prepared using a method well known in the art. The polycarbonate resin may include polypropylene carbonate or polyethylene carbonate having a weight average molecular weight of 2,000˜3,000,000 g/mol, or polycarbonate copolymerized from alkylene oxide and having a weight average molecular weight of 2,000˜3,000,000 g/mol. Specific examples of the alkylene oxide include cyclohexene oxide, glycidyl ester, glycidyl ether, and butylene oxide. The polycarbonate resin may include polycarbonate derived from bisphenol A or hydrogenated bisphenol A, or a copolymer thereof, having a weight average molecular weight of 2,000˜3,000,000 g/mol.

The polyurethane resin composition including the plasticizer according to the present invention may also be prepared using a method well known in the art.

The resin composition according to the present invention has superior physical properties compared to resin compositions including conventional plasticizers. Among physical properties including hardness, tensile strength, elongation, modulus, bleeding and glass transition temperature, the resin composition according to the present invention exhibits hardness of 30˜81 A (Shore A), tensile strength of 120˜220 Kgf/cm², elongation of 200˜500%, modulus of 30˜90 Kgf/cm² and lower glass transition temperature compared to the resin composition having the conventional plasticizer, and bleeding does not occur. The resin composition having the plasticizer according to the present invention has high plasticization efficiency and thus exhibits superior physical properties. In a variety of fields, products having superior physical properties compared to conventional resin compositions or products using the same are expected to be produced.

Also, when plastics are produced from the resin composition including the plasticizer according to the present invention, tensile strength is high and glass transition temperature is low, thus exhibiting high film formability and maintaining flexibility even at low temperature. Accordingly such plastics may be processed into flexible products such as films or artificial leather sheets, and furthermore, may be very compatible with the above resins and thus bleeding does not occur. Moreover, such plastics may dissolve to a smaller extent in organic solvents or water, and the lifetime of products such as films, sheets, etc., resulting from using the resin composition, may be lengthened.

The resin composition including the plasticizer according to the present invention may be used for construction materials, including wall finish materials, bottom materials, window frames, wall paper, etc.; electric wire coating materials; interior or exterior materials for automobiles; agricultural materials for houses, tunnels, etc.; packing materials for food such as fish, including wraps, trays, etc.; coating forming agents, such as underbody sealant, plastic sol, paint, ink, etc.; and miscellaneous goods such as synthetic leather, coated textile, hoses, pipes, sheets, toys, gloves, etc., which are merely illustrative and are not being offered as limitations.

### ADVANTAGEOUS EFFECTS OF INVENTION

According to the present invention, a dicarboxylic acid diester derivative can be used as a plasticizer for a resin composition, and the resin composition can be prepared from the plasticizer and one or more resins selected from among a polyvinyl chloride resin, a polyurethane resin, an epoxy resin and a polycarbonate resin. Thereby, the resulting products can have high plasticization efficiency and also can be improved in terms of physical properties, such as tensile strength, transparency upon forming transparent films, etc.

### MODE FOR THE INVENTION

The following examples and comparative examples, which are set forth to illustrate but are not to be construed as limiting the present invention, may provide a better understanding of the construction and effects of the present invention. In the examples and comparative examples, physical properties were measured by the following methods.

### Hardness

Based on ASTM D2240, the needle of a hardness tester (A Type) was completely put into one portion of a test sample. After 5 sec, the hardness value was recorded. This test was conducted at three portions of each test sample, and the measured values were averaged and used as an indicator for the plasticization efficiency.

Tensile Strength, Elongation, Modulus upon 100% Extension

Measurement was performed using UTM based on ASTM D412. A dumbbell-shaped test sample was pulled at a cross-head speed of 200 mm/min, and the point at which the sample was broken was measured. The modulus upon 100% extension designates tensile strength upon 100% extension, which is closely correlated with compatibility of the plasticizer with the resin.

### Bleeding

At 35° C., a pressure of 0.01 kg/cm² was applied and whether the plasticizer was bled from the surface of a sample was checked. This is correlated with the compatibility between the plasticizer and the resin.

### Glass Transition Temperature

Using DSC, Tg was measured in the range of −30˜100° C. Tg is closely related to the compatibility of the plasticizer.

### EXAMPLE 1

### Preparation of Di(triethylene glycol monomethyl ether)glutarate plasticizer

Into a 2 L round-bottom flask equipped with a stirrer and a condenser, 0.3 mol glutaric acid and 0.8 mol triethylene glycol monomethyl ether were added, and 3 mol % of a sulfuric acid catalyst was added, and the resulting mixture was then heated to 140° C. after which the reaction was carried out for 3 hr.

After the reaction, unreacted triethylene glycol monomethyl ether was removed by decompressing to 5 mmHg using a vacuum pump at 150° C. An adsorbent was added, and the mixture was filtered, yielding di(triethyleneglycol monomethyl ether)glutarate. The product thus obtained was composed mainly of the compound of Chemical Formula 1, and had impurities such as a small amount of triethylene glycol monomethyl ether or glutaric acid.

¹H NMR (CDCl₃, 500 Hz) δ 4.31-4.25(t, 4H), 3.69-3.71(t, 4H), 3.65-6.67(m, 12H), 3.55-3.57(t, 4H), 3.39(s, 6H), 2.40-2.43(t, 4H), 1.96-1.98(m, 2H)

### EXAMPLE 2

### Preparation of Di(triethylene glycol monomethyl ether)succinate plasticizer

In a 500 ml round-bottom flask equipped with a stirrer and a condenser, 0.3 mol succinic anhydride and 0.8 mol triethylene glycol monomethyl ether were dissolved in benzene, and 3 mol % of a p-toluene sulfonic acid monohydrate (p-TsOH) catalyst was added, and water was removed using Dean-Stark distillation, after which the reaction was carried out for 12 hr.

After the reaction, p-TsOH and a carboxylic acid by-product were removed using water. The unreacted triethylene glycol monomethyl ether was removed by decompressing to 1˜5 mmHg using a vacuum pump at 150° C., yielding di(triethylene glycol monomethyl ether)succinate. This product was composed mainly of the compound of Chemical Formula 1.

¹H NMR (CDCl₃, 500 Hz) δ 4.25-4.27(t, 4H), 3.67-3.71(m, 6H), 3.45-3.67(m, 10H), 3.55-3.57(m, 4H), 3.39(s, 6H), 2.67(s, 4H)

### EXAMPLE 3

### Preparation of Di(tripropylene glycol monomethyl ether)succinate plasticizer

Di(tripropylene glycol monomethyl ether)succinate was synthesized from tripropylene glycol monomethyl ether in the same manner as in Example 2.

¹H NMR (CDCl₃, 500 Hz) δ 5.04-5.06(m, 2H), 3.59-3.62(m, 2H), 3.55-3.50(m, 6H), 3.62-3.40(m, 20H), 2.6(s, 6H), 2.30-3.33(m, 2H), 1.23-1.24(m, 6H), 1.13-1.14(m, 6H)

### EXAMPLE 4

### Preparation of Di(dipropylene glycol monomethyl ether)succinate plasticizer

Di(dipropylene glycol monomethyl ether)succinate was synthesized from dipropylene glycol monomethyl ether in the same manner as in Example 2.

¹H NMR (CDCl₃, 500 Hz) δ 5.04-5.06(m, 2H), 3.59-3.62(m, 2H), 3.53-3.51(m, 4H), 3.61-3.41(m, 8H), 2.6(s, 4H), 2.30-3.33(m, 2H), 1.23-1.24(m, 6H), 1.13-1.14(m, 6H)

### EXAMPLE 5

### Preparation of Di(triethylene glycol monomethyl ether)malonate plasticizer

In a 2L round-bottom flask equipped with a stirrer and a condenser, 0.3 mol malonic acid and 0.8 mol triethylene glycol monomethyl ether were dissolved in toluene, and 3 mol % of p-TsOH was added, and water was then removed using dean-stark distillation, after which the reaction was carried out for 12 hr.

The unreacted triethylene glycol monomethyl ether was removed by decompressing to 1˜5 mmHg using a vacuum pump at 150° C., and small amounts of triethylene glycol monomethyl ether, p-TsOH and carboxylic acid were removed using silica column chromatography, yielding di(triethylene glycol monomethyl ether)malonate. This product was composed mainly of the compound of Chemical Formula 1.

¹H NMR (CDCl₃, 500 Hz) δ 4.31-4.25(t, 4H), 3.69-3.71(t, 4H), 3.65-6.67(m, 12H), 3.55-3.57(t, 4H), 3.39(s, 6H), 3.35(s, 2H), 2.40-2.43(t, 4H)

### EXAMPLE 6

### Preparation of Resin Composition

In order to evaluate the performance of the plasticizers of Examples 1 to 5, test samples were manufactured. Specifically, a polyvinyl chloride resin composition was prepared by mixing 100 parts by weight of a polyvinyl chloride resin (LS-100, available from LG Chemical) with 50 parts by weight of a plasticizer composition composed mainly of the plasticizer of Examples 1 to 5 and 1 part by weight of a stabilizer LFX-1100 (available from Korea Daehyup Chemical), and subjecting the mixture to preheating at 185° C. for 1 min, compression for 1.5 min using a press and cooling for 2 min, thus making a 2 mm thick sheet, which was then formed into a variety of dumbbell-shaped test samples. Also, a polyurethane resin composition was prepared by mixing a polyol having a molecular weight of 3000 g/mol and 4,4′-dihexyl methane diisocyanate (H12MDI) at an equivalent ratio of 3:1, adding 10% of a plasticizer based on the total weight of the composition and a 0.1% DBTDL catalyst, applying the resulting mixture on release paper and curing it at 150° C. for 1 min thus obtaining a sheet. Also, an epoxy sheet was manufactured by mixing 100 parts by weight of an epoxy resin (diglycidyl ether bisphenol A; DGEBA, YD-128) with 30 parts by weight of a curing agent (4,4-diaminodiphenylmethane; DDM) and 10% of a plasticizer based on the total weight of the composition, applying the resulting mixture on release paper, and curing it at room temperature for one day. Also a polycarbonate sheet was manufactured by mixing 100 parts by weight of polypropylene carbonate having a molecular weight of 300,000 g/mol with 10 parts by weight of a plasticizer using a 3-roll mill, and extruding the mixture.

The plasticizers and the test samples were tested as above. The results are summarized in Table 1 below.

### Comparative Example 1

A test sample was manufactured in the same manner as in Example 6 using di-2-ethylhexylphthalate which is a very widely available plasticizer. The test sample was tested as in Example 6. The results are summarized in Table 1 below.

### Comparative Example 2

A test sample was manufactured in the same manner as in Example 6 without the use of a plasticizer. The test sample was tested as in Example 6. The results are summarized in Table 1 below. PVC is not processed without the plasticizer, and is thus excluded.

TABLE 1

| | | | Tensile | | | | |
|---|---|---|---|---|---|---|---|
| | | Hardness, | Strength, | Elongation, | Modulus, | | Tg |
| Resin | Plasticizer | Shore A | Kgf/cm² | % | Kgf/cm² | Bleeding | (° C.) |
| PVC | Ex. 1 | 71 | 175 | 292 | 85 | No | — |
| | Ex. 2 | 73 | 177 | 289 | 84 | No | — |
| | Ex. 3 | 74 | 190 | 295 | 79 | No | — |
| | Ex. 4 | 75 | 220 | 268 | 90 | No | — |
| | Ex. 5 | 77 | 164 | 275 | 89 | No | — |
| | C. Ex. 1 | 82 | 102 | 269 | 88 | No | — |
| | C. Ex. 2 | — | — | — | — | — | — |
| PU | Ex. 1 | 72 | 195 | 247 | 80 | No | −36 |
| | Ex. 2 | 71 | 199 | 242 | 81 | No | −37 |
| | Ex. 3 | 72 | 198 | 249 | 80 | No | −36 |
| | Ex. 4 | 77 | 201 | 231 | 86 | No | −37 |
| | Ex. 5 | 81 | 190 | 228 | 88 | No | −36 |
| | C. Ex. 1 | 81 | 187 | 192 | 91 | Yes | −35 |
| | C. Ex. 2 | 89 | 192 | 182 | 97 | No | −33 |
| EPOXY | Ex. 1 | 75 | 200 | 285 | 84 | No | 96 |
| | Ex. 2 | 78 | 212 | 287 | 83 | No | 96 |
| | Ex. 3 | 79 | 217 | 281 | 83 | No | 100 |
| | Ex. 4 | 81 | 209 | 221 | 87 | No | 103 |
| | Ex. 5 | 81 | 208 | 207 | 88 | No | 110 |
| | C. Ex. 1 | 97 | 201 | 193 | 90 | No | 113 |
| | C. Ex. 2 | 105 | 218 | 179 | 93 | No | 120 |
| PPC | Ex. 1 | 39 | 123 | 473 | 31 | No | 9 |
| | Ex. 2 | 39 | 122 | 485 | 30 | No | 13 |
| | Ex. 3 | 40 | 126 | 461 | 33 | No | 16 |
| | Ex. 4 | 45 | 123 | 432 | 35 | No | 15 |
| | Ex. 5 | 48 | 125 | 420 | 30 | No | 16 |
| | C. Ex. 1 | 52 | 117 | 399 | 30 | Yes | 24 |
| | C. Ex. 2 | 56 | 123 | 386 | 39 | No | 36 |

As is apparent from the results of Table 1, the plasticizers of Examples 1 to 5 according to the present invention exhibited superior plasticization efficiency and was higher in terms of the other physical properties of for example tensile strength, glass transition temperature, etc., compared to the general-purpose plasticizer of Comparative Example 1. Also, as the results of the comparative examples show, the plasticizers of the present invention did not cause bleeding compared to the conventional general-purpose plasticizer. Thus, the plasticizers of the present invention manifest high plasticization efficiency, and can thus be variously utilized and molded so as to be adapted for a variety of end uses.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

According to the present invention, a dicarboxylic acid diester derivative can be used as a plasticizer for a resin composition, and the resin composition can be prepared from the plasticizer and one or more resins selected from among a polyvinyl chloride resin, a polyurethane resin, an epoxy resin and a polycarbonate resin. Thereby, the resulting products can have high plasticization efficiency and also can be improved in terms of physical properties, such as tensile strength, transparency upon forming transparent films, etc.

1. A plasticizer for a resin composition, represented by Chemical Formula 1 below: 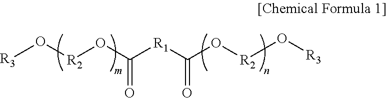
wherein R₁ and R₂ independently represent linear or branched (C1-C8)alkylene, alicyclic (C5-C10)alkylene or (C6-C12)arylene; R₃ represents linear or branched (C1-C18)alkyl, alicyclic (C5-C10)alkyl or (C6-C12)aryl; and m and n independently represent an integer of 0˜8, provided that a case where both m and n are 0 is excluded.

2. The plasticizer of claim 1, wherein the resin is one or more selected from among a polyvinyl chloride resin, a polyurethane resin, a polycarbonate resin and an epoxy resin.

3. A resin composition, comprising one or more resins selected from among a polyvinyl chloride resin, a polyurethane resin, a polycarbonate resin and an epoxy resin, and a plasticizer represented by Chemical Formula 1 below: 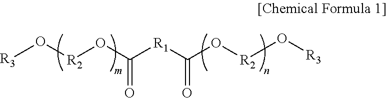
wherein R₁ and R₂ independently represent linear or branched (C1-C8)alkylene, alicyclic (C5-C10)alkylene or (C6-C12)arylene; R₃ represents linear or branched (C1-C18)alkyl, alicyclic (C5-C10)alkyl or (C6-C12)aryl; and m and n independently represent an integer of 0˜8, provided that a case where both m and n are 0 is excluded.

4. The resin composition of claim 3, wherein the plasticizer represented by Chemical Formula 1 is contained in an amount of 5˜150 parts by weight based on 100 parts by weight of the one or more resins.

5. The resin composition of claim 3, wherein the epoxy resin is added with the plasticizer before a curing reaction is carried out by a curing agent.

6. The resin composition of claim 3, wherein the polycarbonate is polypropylene carbonate or polyethylene carbonate having a weight average molecular weight of 2,000˜3,000,000 g/mol.

7. The resin composition of claim 3, wherein the polycarbonate is a copolymer of polypropylene carbonate or polyethylene carbonate and alkylene oxide, having a weight average molecular weight of 2,000˜3,000,000 g/mol.

8. The resin composition of claim 7, wherein the alkylene oxide is selected from among cyclohexene oxide, glycidyl ester, glycidyl ether, and butylene oxide.

9. The resin composition of claim 3, wherein the polycarbonate is a polycarbonate derived from bisphenol A or hydrogenated bisphenol A, or a copolymer thereof, having a weight average molecular weight of 2,000˜3,000,000 g/mol.
